(19) United States
(12) Patent Application Publication
(10) Pub. No.: US 2008/0219415 A1
(43) Pub. Date: Sep. 11, 2008

(54) APPARATUS AND METHOD FOR PROVIDING A VOICE MESSAGE IN A COMMUNICATION SYSTEM

(75) Inventors: Jae-Hyuk JANG, Suwon-si (KR); Dong-Seek PARK, Yongin-si (KR); Pan-Yuh JOO, Seoul (KR); Jung-Je SON, Seongnam-si (KR); Young-Ho KIM, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/045,363

(22) Filed: Mar. 10, 2008

(30) Foreign Application Priority Data
Mar. 9, 2007 (KR) 2007-0023522

(51) Int. Cl. H04M 3/533

(52) U.S. Cl. 379/88.06

(57) ABSTRACT

A method and apparatus for providing a voice message in a communication system are provided. Upon receiving a request message for providing a voice message to a calling terminal, a caller information detector determines whether the request message includes language select information indicating a language of a voice message to be provided to the calling terminal, and detects caller information included in the request message when the language select information is not included. A voice message reproducer selects a language of a voice message to be provided to the calling terminal using the detected caller information, and transmits a voice message corresponding to the selected language to the calling terminal. Accordingly, the calling terminal can receive voice messages in a language appropriate for the user.

### PRIORITY

This application claims the benefit under 35 U.S.C. §119(a) of a Korean patent application filed in the Korean Intellectual Property Office on Mar. 9, 2007 and assigned Serial No. 2007-23522, the entire disclosure of which is hereby incorporated by reference.

### BACKGROUND OF THE INVENTION

1. Field of the Invention

The present invention relates to an apparatus and method for providing a user service in a communication system. More particularly, the present invention relates to an apparatus and method for providing a voice message in a communication system.

2. Description of the Related Art

In a conventional communication system, when a first user desires to call the second user, the first user performs a call setup with a terminal of a second user using the first user's terminal. When the call setup is completed, the corresponding users can perform the call with each other.

However, after transmitting the call setup request to a terminal of a called party (‘called terminal’), the terminal of a calling party or a caller (‘calling terminal’) cannot perform a call with the called terminal until it receives a response to the call setup request from the called terminal.

In some circumstances, it may not be possible to complete the call, for example due to a problem of the called terminal or the unavailability of the called terminal user. In this case, if there is no response to the call setup request from the called terminal for a preset time, a called switching center provides the calling terminal with a message indicating that the called terminal is in a call unavailable state. In addition, the switching center can manage a Voice Mail System (VMS) that permits the calling terminal to leave a voice message for the called terminal. A configuration of a conventional communication system supporting the VMS service will be described below with reference to FIG. 1.

FIG. 1 is a diagram illustrating a configuration of a conventional communication system supporting a voice message.

Referring to FIG. 1, the communication system includes a wired terminal 101, a switching center 103, a communication network 105, a gateway 107, a Mobile Switching Center (MSC) 109, a Base Station Controller (BSC) 111, a Base Station (BS) 113, a Mobile Station (MS) 115, and a VMS 150.

The term ‘communication system’ as used herein refers to various wired or wireless communication systems, and the communication system may be connected to other communication systems over the communication network 105. Herein, the communication network 105 can be, for example, a Public Switched Telephone Network (PSTN).

The wired communication system includes the wired terminal 101 and the switching center 103.

Herein, the switching center 103 is connected to the wired terminal 101, and provides an associated circuit switched service to the wired terminal 101 located in a local service area for performing call processing. Further, the switching center 103 is connected to the communication network 105.

The wireless communication system includes the MS 115, the BS 113, the BSC 111, the MSC 109, and the gateway 107.

The gateway 107 provides a connection between communication networks supporting different protocols, performs protocol conversion, and enables mutual connection between the communication network 105 and the MSC 109. The MSC 109 performs call processing on the signal received/transmitted over the BS 113, and controls the BSC 111. The BSC 111, connected to the MSC 109, controls and manages a plurality of BSs including the BS 113. The BS 113 provides a communication service to the MS 115 located in a specific service area, for example, a cell.

In the following description, the wired terminal 101 is assumed to be a calling terminal, and the MS 115 is assumed to be a called terminal.

To make a call with the MS 115, the wired terminal 101 transmits a call setup request message to the switching center 103. In response to the call setup request, the switching center 103 transmits the call setup request message to the gateway 107 of the wireless communication system over the communication network 105, and the gateway 107 transmits the call setup request message to the MSC 109. In response to the call setup request, the MSC 109 transmits the call setup request message to the MS 115 over the BSC 111 and the BS 113. In addition, the MSC 109 transmits a ring back tone to the wired terminal 101. If there is no response from the called terminal, i.e., the MS 115, for a preset time, the MSC 109 transmits a request for VMS connection to the VMS 150 because the call setup has not been successfully completed.

In order to notify the calling terminal, i.e., the wired terminal 101, that the MS 115 is in a call unavailable state, the VMS 150 transmits, for example, a message “You will be connected to VMS due to the unavailability of the called party. If you want to record a message, please push the ‘#’-button”. Thereafter, in response to a request from the wired terminal 101, the VMS 150 provides recorded information message, and records a voice of the caller. Alternatively, the VMS 150 stops the operation in response to a call setup end request.

However, in the conventional system, the voice message is reproduced (played back) only in one language, i.e., only in the language of the country where the corresponding system is managed. Therefore, when the caller uses a language different from the language supported in the VMS, the caller may be inconvenienced and may not normally receive the VMS service. Moreover, even if the caller understands and uses the language supported in the VMS, the caller must receive the message in the language supported by the VMS service, regardless of whether the user prefers to receive the voice message in a another language.

As described above, in the conventional communication system, the VMS service is provided using a message configured only in one language supported by the VMS. Therefore, the user cannot receive the message configured in various languages.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for providing a voice message in various languages in a communication system.

Another aspect of the present invention is to provide an apparatus and method for providing a voice message configured in various languages during a VMS service in a communication system.

According to one aspect of the present invention, a method for providing a voice message by a Voice Mail System (VMS) in a communication system is provided. The method includes receiving a request message for providing a voice message to a calling terminal, determining whether the request message includes language select information indicating a language of a voice message to be provided to the calling terminal, when the language select information is not included, detecting caller information included in the request message, selecting a language of a voice message to be provided to the calling terminal using the detected caller information and transmitting a voice message corresponding to the selected language to the calling terminal.

According to another aspect of the present invention, an apparatus for providing a voice message in a communication system is provided. The apparatus includes a caller information detector to, upon receiving a request message for providing a voice message to a calling terminal, determine whether the request message includes language select information indicating a language of a voice message to be provided to the calling terminal, and detect caller information included in the request message when the language select information is not included and a voice message reproducer to select a language of a voice message to be provided to the calling terminal using the detected caller information, and transmitting a voice message corresponding to the selected language to the calling terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 is a diagram illustrating a configuration of a conventional communication system providing a voice message;

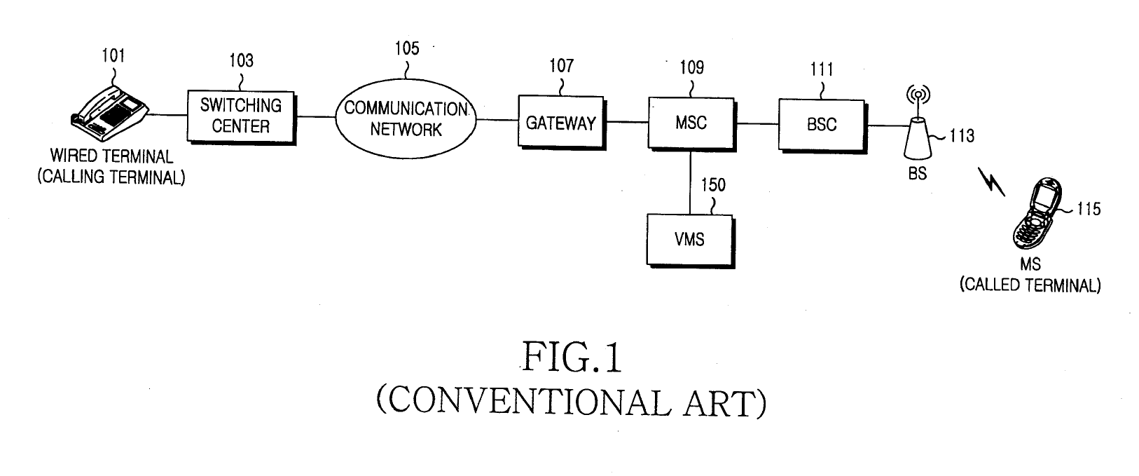

FIG. 2 is a diagram schematically illustrating a configuration of a communication system providing a voice message according to an exemplary embodiment of the present invention;

FIG. 3 is a diagram schematically illustrating a configuration of a communication system providing a voice message according to another exemplary embodiment of the present invention;

FIG. 4 is a signal flow diagram schematically illustrating a method for providing a voice message in a communication system according to an exemplary embodiment of the present invention; and

FIG. 5 is a flowchart illustrating an operation of a voice message providing apparatus according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention provides an apparatus and method for providing a voice message in a communication system. To this end, exemplary embodiments of the present invention store two or more voice messages configured in different languages in a VMS, select a corresponding language using information provided by a calling terminal or information about the calling terminal, and transmits a voice message corresponding to the selected language to the calling terminal.

In exemplary embodiments of the present invention, the communication system includes both wired and wireless communication systems so that the called terminal and the calling terminal can be a wired terminal, a Mobile Station (MS) or another wireless terminal. For convenience, exemplary embodiments of the present invention will be described herein for call setup between a wired terminal and a wired terminal, and between a wired terminal and an MS, by way of example. However, it is to be understood that this for ease of description only and the present invention is not limited to terminals using a specific communication technology.

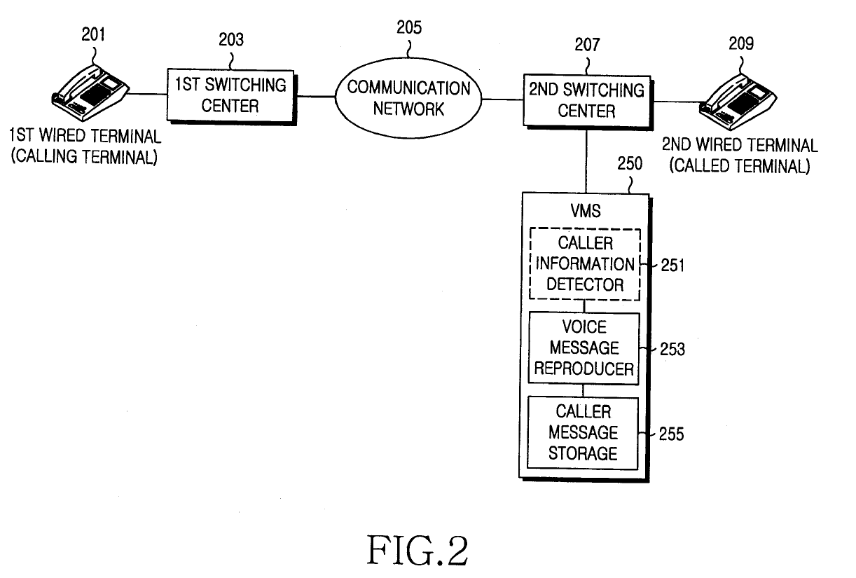

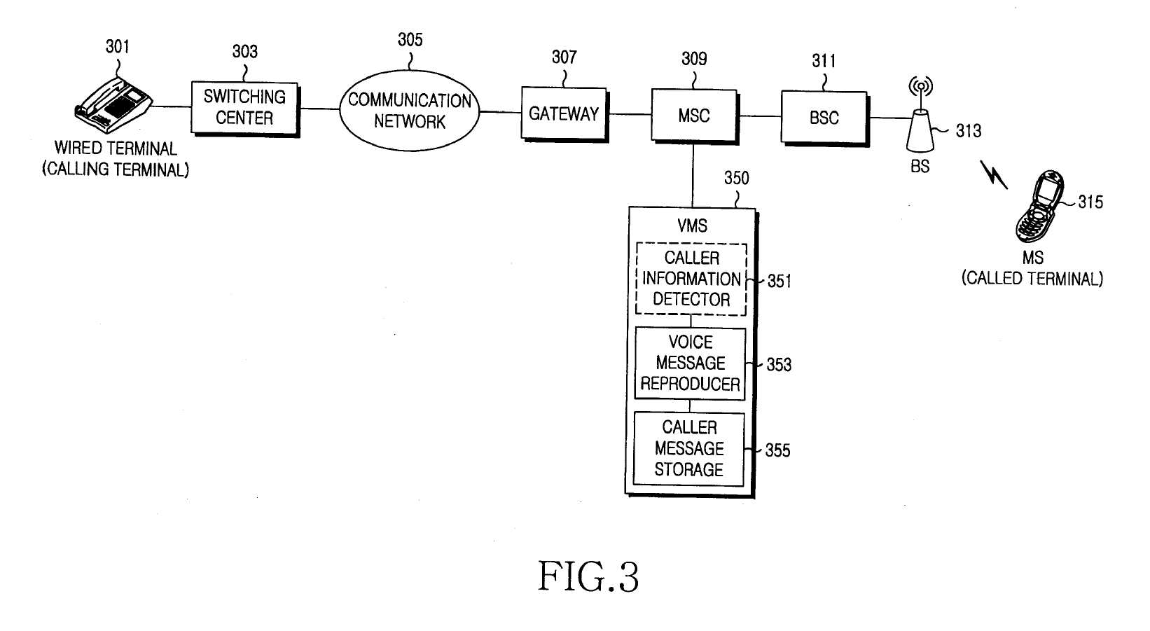

With reference to FIGS. 2 and 3, a description will now be made of a communication system supporting a voice message.

FIG. 2 is a diagram schematically illustrating a configuration of a communication system providing a voice message according to an exemplary embodiment of the present invention.

Referring to FIG. 2, the communication system includes a first wired terminal 201, a first switching center 203, a communication network 205, a second switching center 207, a second wired terminal 209, and a Voice Mail System (VMS) 250.

Herein, the communication network 205 can be, for example, a Public Switched Telephone Network (PSTN).

The first switching center 203 and the second switching center 207 are connected to the first wired terminal 201 and the second wired terminal 209, respectively. Furthermore, the first switching center 203 and the second switching center 207 provide associated circuit switched services to the wired terminals 201 and 209 located in their local service areas, respectively. Also, the first switching center 203 and the second switching center 207 are each connected to the communication network 205.

In an exemplary embodiment of the present invention, the first wired terminal 201 is assumed to be a calling terminal and the second wired terminal 209 is assumed to be a called terminal.

To setup a call with the second wired terminal 209, the first wired terminal 201 transmits a call setup request message to the first switching center 203. In response to the call setup request, the first switching center 203 transmits the call setup request message to the second switching center 207 over the communication network 205.

In response to the call setup request, the second switching center 207 transmits the call setup request message, i.e., a call accept request message, to the second wired terminal 209. The second switching center 207 also transmits a ring back tone to the first wired terminal 201.

If there is no response from the called terminal, i.e., the second wired terminal 209, for a time period, the second switching center 207 transmits a VMS connection request to the VMS 250 connected to the second switching center 207 because the call setup has not been successfully completed.

A voice message providing apparatus according to an exemplary embodiment of the present invention, i.e., the VMS 250, includes a caller information detector 251, a voice message reproducer 253, and a caller message storage 255.

Upon receiving a VMS connection request message from the second switching center 207 due to the failure of the call setup, the caller information detector 251 included in the VMS 250 detects caller information from the VMS connection request message. Herein, the caller information can be, for example, a Caller Identifier (CID) that may include a phone number of the calling terminal. Furthermore, the caller information may include information other than or in addition to the CID, such as caller location information and caller country information, from which the language used by the caller can be detected. Therefore, in an exemplary implementation, the caller information detector 251 can detect, from the caller information, the caller's location and the caller's country information (e.g., acquired from a country code included in the phone number).

According to another exemplary embodiment of the present invention, the call setup request message sent by the calling terminal, i.e., the first wired terminal 201, includes the caller information.

Upon detecting the caller information, the caller information detector 251 outputs the detected caller information to the voice message reproducer 253. Upon receiving the caller information, the voice message reproducer 253 selects a language corresponding to the first wired terminal 201, using the received caller information.

The voice message reproducer 253 can include a separate memory (not shown) in which voice messages configured in various languages associated with various countries are stored.

The voice message reproducer 253 determines whether there is any voice message configured in the selected caller's language. If it is determined that there is a voice message configured in the selected caller's language, the voice message reproducer 253 transmits the voice message stored in the corresponding language to the first wired terminal 201 over the second switching center 207. However, if it is determined that it cannot provide the voice message in the selected language, the voice message reproducer 253 transmits a voice message stored in a default language in the voice message reproducer 253 to the first wired terminal 201 over the second switching center 207.

More specifically, in response to the VMS connection request from the second switching center 207, the voice message reproducer 253 provides, in the selected language, a voice message notifying the caller that there is no response to the call setup request. In an exemplary implementation, the message may include text such as “You will be connected to VMS due to the unavailability of the called party. If you want to record a message, please push the ‘#’-button”.

Thereafter, upon receiving a request for recording the caller's voice, i.e., receiving a request from the first wired terminal 201 to leave a caller message, the voice message reproducer 253 provides a recorded voice message to the first wired terminal 201 in the selected language. In an exemplary implementation, the message may include text such as “Please record your message after the ‘beep’ sound.” In addition, in response to the request for recording the caller's message from the first wired terminal 201, the VMS 250 stores the message in the caller message storage 255.

If there is no request for recording the caller message, the voice message reproducer 253 ends the voice message providing operation.

In an exemplary embodiment of the present invention, the calling terminal, i.e., the first wired terminal 201, may include a language select function for the voice message and can transmit the corresponding language information along with the call setup request message.

In this case, the caller information detector 251 is optional because the voice message reproducer 253 can directly acquire the language information included in the call setup request message and provide a voice message corresponding to the acquired language information.

FIG. 3 is a diagram schematically illustrating a configuration of a communication system providing a voice message according to another exemplary embodiment of the present invention.

Referring to FIG. 3, the communication system includes a wired terminal 301, a switching center 303, a communication network 305, a gateway 307, a Mobile Switching Center (MSC) 309, a Base Station Controller (BSC) 311, a Base Station (BS) 313, a Mobile Station (MS) 315, and a VMS 350.

The term ‘communication system’ as used herein refers to various wired or wireless communication systems, and the communication system may be connected to other communication systems over the communication network 305. Herein, the communication network 305 can be, for example, a PSTN.

The wired communication system includes the wired terminal 301 and the switching center 303.

Herein, the switching center 303 is connected to the wired terminal 301, and provides an associated circuit switched service to the wired terminal 301 located in a local service area for performing call processing. Further, the switching center 303 is connected to the communication network 305.

The wireless communication system includes the MS 315, the BS 313, the BSC 311, the MSC 309, and the gateway 307.

The gateway 307 provides a connection between communication networks supporting different protocols, performs protocol conversion, and enables mutual connection between the communication network 305 and the MSC 309. The MSC 309 performs call processing on the signal transmitted/received over the BS 313, and controls the BSC 311. The BSC 311, connected to the MSC 309, controls and manages a plurality of BSs including the BS 313. The BS 313 provides a communication service to the MS 315 located in a specific service area, for example, a cell.

In an exemplary implementation, the wired terminal 301 is assumed to be a calling terminal and the MS 315 is called a called terminal.

To setup a call with the MS 315, the wired terminal 301 transmits a call setup request message to the switching center 303. In response to the call setup request, the switching center 303 transmits the call setup request message to the gateway 307 of the wireless communication system over the communication network 305. The gateway 307 transmits the call setup request message to the MSC 309.

In response to the call setup request, the MSC 309 transmits the call setup request message to the MS 315 over the BSC 311 and the BS 313. Further, the MSC 309 transmits a ring back tone to the wired terminal 301.

If there is no response from the called terminal, i.e., MS 315, for a time period, the switching center, i.e., MSC 309, transmits a request for VMS connection to the VMS 350 connected to the MSC 309 because the call setup has not been successfully completed.

A voice message providing apparatus according to an exemplary embodiment of the present invention, i.e., the VMS 350, includes a caller information detector 351, a voice message reproducer 353, and a caller message storage 355.

Upon receiving a VMS connection request message from the MSC 309 due to the failure of the call setup, the caller information detector 351 in the VMS 350 detects caller information included in the VMS connection request message. The caller information may include a CID. Furthermore, the caller information may include information other than or in addition to the CID, such as caller location information and caller country information, from which the language used by the caller can be detected.

In an exemplary implementation, the CID included in the caller information can be, for example, a phone number of the calling terminal, and the caller information detector 351 can detect from the CID a location of the caller using the calling terminal, and the caller's country information (for example, acquired from a country code included in the phone number). Therefore, when the caller information includes information such as the CID, the caller location information and the caller country information, from which the language used by the caller and the language to be transmitted by the VMS 350, can be detected.

According to another exemplary embodiment of the present invention, the call setup request message sent by the calling terminal, i.e., wired terminal 301, includes the caller information.

Upon detecting the caller information, the caller information detector 351 outputs the detected caller information to the voice message reproducer 353. Upon receiving the caller information, the voice message reproducer 353 selects a language corresponding to the wired terminal 301, using the received caller information.

The voice message reproducer 353 has stored therein voice messages configured in various languages associated with various countries, or can include a separate memory (not shown) in which the voice messages are stored.

The voice message reproducer 353 determines whether there is any voice message configured in the selected caller's language. If it is determined that it can provide a voice message in the selected language, the voice message reproducer 353 transmits the voice message stored in the corresponding language to the wired terminal 301 over the MSC 309. However, if it is determined that it cannot provide the voice message in the selected language, the voice message reproducer 353 sends a voice message stored in a default language in the voice message reproducer 353 to the wired terminal 301 over the MSC 309.

More specifically, in response to the VMS connection request from the MSC 309, the voice message reproducer 353 provides, in the selected language, a voice message notifying the caller that there is no response to the call setup request. In an exemplary implementation, the message may include text such as “You will be connected to VMS due to the unavailability of the called party. If you want to record a message, please push the ‘#’-button’.

Thereafter, upon receiving a request for recording the caller's voice, i.e., receiving a request from the wired terminal 301 to leave a caller message, the voice message reproducer 353 provides a recorded voice message to the wired terminal 301 in the selected language. In an exemplary implementation, the message may include text such as “Please record your message after the ‘beep’ sound”. In addition, in response to the request for recording the caller message from the wired terminal 301, the VMS 350 stores the caller message in the caller message storage 355.

If there is no request for recording the caller message, the voice message reproducer 353 ends the voice message providing operation.

In an exemplary embodiment of the present invention, the calling terminal, i.e., wired terminal 301, may include a language select function for the voice message and can transmit the corresponding language information along with the call setup request message.

In this case, the caller information detector 351 is optional because the voice message reproducer 353 can directly acquire the language information included in the call setup request message and provide the detected voice message corresponding to the acquired language information.

Although a description of FIGS. 2 and 3 has been made for the case where the calling terminal is a wired terminal, it is not intended to limit the calling terminal to a wired terminal, and the calling terminal can also be an MS. Similarly, the called terminal can also be either a wired terminal or an MS.

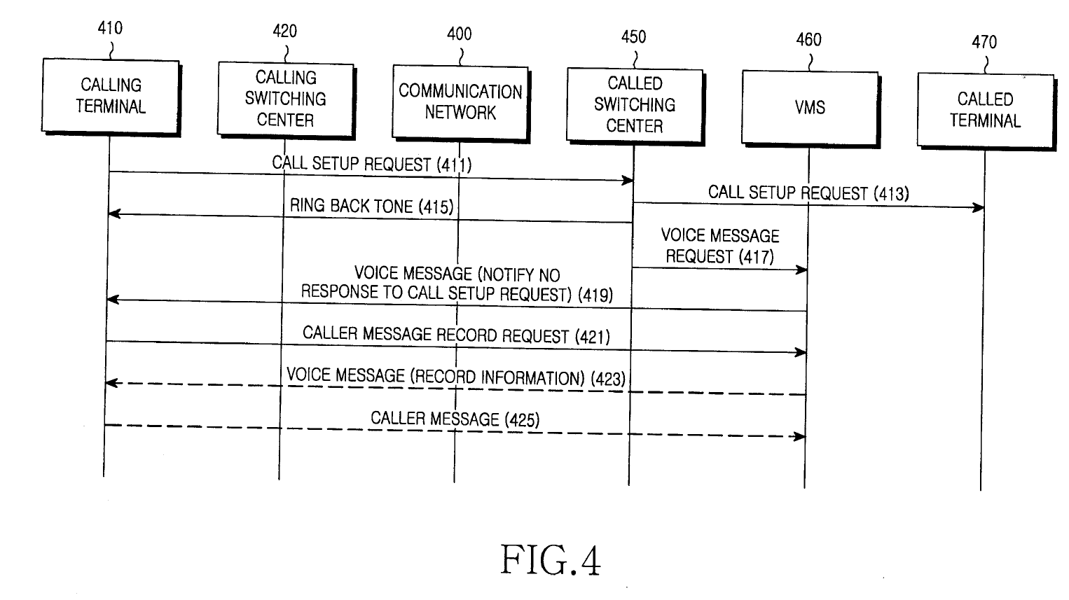

With reference to FIG. 4, a description will now be made of an operation of a communication system according to an exemplary embodiment of the present invention.

FIG. 4 is a signal flow diagram schematically illustrating a method for providing a voice message in a communication system according to an exemplary embodiment of the present invention.

Referring to FIG. 4, the communication system includes a calling terminal 410, a calling switching center 420, a communication network 400, a called switching center 450, a VMS 460, and a called terminal 470.

The calling terminal 410 transmits a call setup request message to the called terminal 470 to which it intends to make a call. The call setup request message is transmitted to the called switching center 450 in step 411. It should be noted that although FIG. 4 illustrates in step 411 that the setup request is made directly from the calling terminal 410 to the called switching center 450, this is for example only. In another exemplary implementation, the call setup request may be made to the calling switching center 420 and transferred to the called switching center 450 through the communication network 400. The calling terminal 410 includes caller information in the call setup request message. According to an exemplary embodiment of the present invention, the caller information includes information from which a language to be used for providing the corresponding voice message can be selected.

In another exemplary implementation, the calling terminal 410, when it can select a language to be used for providing the voice message, selects a language to be used for providing the voice message, and includes the selected language information in the call setup request message.

Upon receiving the call setup request message, the called switching center 450 transmits a request for call setup to the called terminal 470 in step 413. The called switching center 450 also transmits a ring back tone to the calling terminal 410 in step 415.

Thereafter, if there is no response to the call setup request made in step 413 for a time period, the called switching center 450 transmits a voice message request message to the VMS 460 in step 417. The voice message request message includes the caller information included in the call setup request message, or includes the selected language information. In response to the voice message request message, the VMS 460 selects a language to be used for providing the voice message.

Using the selected language, the VMS 460 transmits a voice message notifying that there is no response to the call setup request to the calling terminal 410 in step 419. Therefore, the calling terminal 410 can receive a voice message made in the language of the calling terminal user. Further, the calling terminal 410 determines whether it intends to place a caller message in reply to the voice message. If it intends to place a caller message, the calling terminal 410 transmits a caller message record request message to the VMS 460 in step 421.

In response to the caller message record request, the VMS 460 transmits a voice message, in the selected language, for storing a caller message to the calling terminal 410 in step 423. Herein, the sent voice message is recorded information prompting the caller to place the caller message.

Upon receiving the voice message made in the language of the calling terminal user, the calling terminal 410 provides a voice message to the VMS 460 and stores the voice message therein in step 425. According to an exemplary embodiment of the present invention, the voice message sent to the calling terminal 410 can be stored in the VMS 460, or can be received from a terminal user in the communication system.

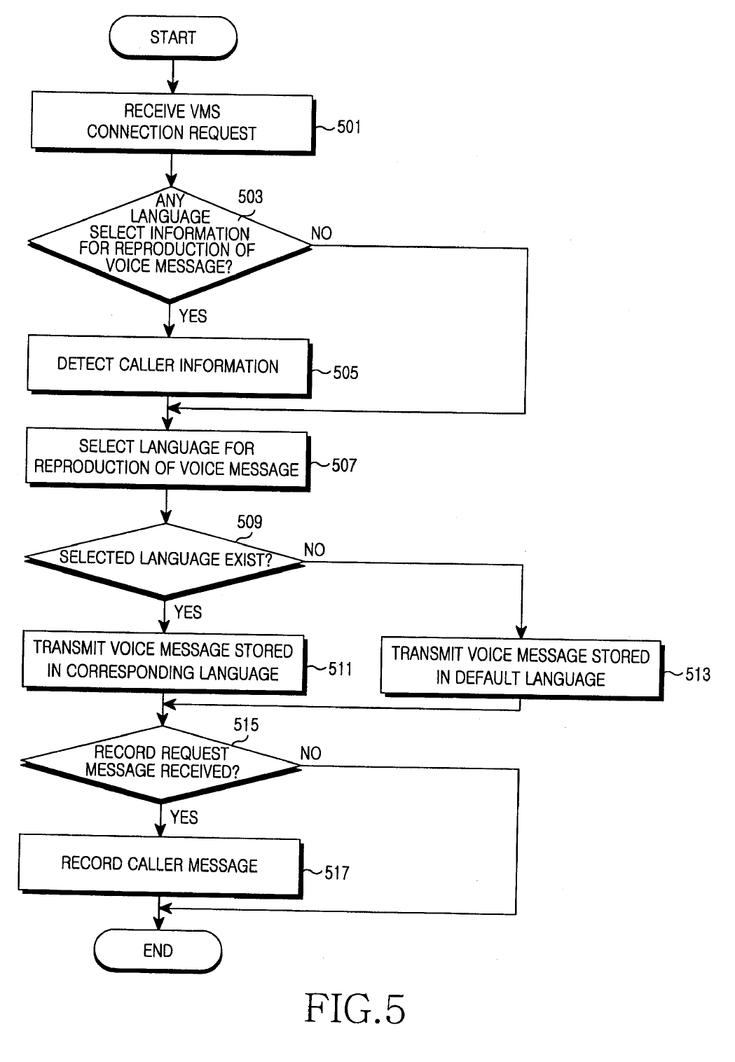

With reference to FIG. 5, a description will now be made of an operation of a VMS, i.e., voice message providing apparatus, according to an exemplary embodiment of the present invention.

FIG. 5 is a flowchart illustrating an operation of a voice message providing apparatus according to an exemplary embodiment of the present invention.

Referring to FIG. 5, in step 501, the voice message providing apparatus receives a VMS connection request from a switching center. In step 503, the voice message providing apparatus determines whether there is any language select information, indicating a language to be used for reproducing the voice message, in the connection request. If it is determined that there is language select information, the voice message providing apparatus proceeds to step 507. However, if it is determined that there is no language select information, the voice message providing apparatus proceeds to step 505.

In step 505, the voice message providing apparatus detects caller information. In step 507, the voice message providing apparatus selects a language to be used for reproducing the voice message using the caller information or the language select information. Herein, the selected language covers languages used in various countries or regions all over the world, such as English, Korean, Chinese, Japanese, French, German, etc.

In step 509, the voice message providing apparatus determines whether a voice message in the selected language exists in the voice message providing apparatus, or in a memory that operates in association with the voice message providing apparatus. If it is determined that there is a voice message configured in the corresponding language, the voice message providing apparatus proceeds to step 511 where it transmits the stored voice message using the selected language and then proceeds to step 515.

However, if it is determined that there is no voice message stored in the corresponding language, the voice message providing apparatus proceeds to step 513 where it transmits a voice message stored in a default language set in the voice message providing apparatus, and then proceeds to step 515.

In step 515, the voice message providing apparatus determines whether a record request message for storing a caller message is received. If it is determined that a record request message is received, the voice message providing apparatus proceeds to step 517 where it transmits recorded information prompting the caller to place a message, receives a caller voice message and records the caller message. However, if it is determined that the record request message is not received, the voice message providing apparatus ends the operation.

The voice message providing apparatus illustrated by exemplary embodiments of the present invention include the caller information detector and the caller message storage shown in FIGS. 2 and 3. Either of the caller information detector and the caller message storage may be located inside or outside the switching center to perform the voice message providing operation.

In addition, the foregoing voice message providing apparatus according to exemplary embodiments of the present invention can be simply added to a conventional VMS apparatus, or can provide a new value-added service through upgrade.

As is apparent from the foregoing description, exemplary embodiments of the present invention can receive a voice message in various languages in a communication system. In addition, exemplary embodiments of the present invention can receive a voice message made in various languages during a VMS service. Further, exemplary embodiments of the present invention determine caller information and provide a voice message corresponding thereto so that callers can conveniently receive the VMS service in their native language. Furthermore, exemplary embodiments of the present invention can provide a VMS message specified only to the person. Moreover, exemplary embodiments of the present invention can provide a new value-added service by simply adding the structure of the voice message providing apparatus or upgrading the VMS, without a significant modification of the existing communication system from the standpoint of the service provider.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for providing a voice message by a Voice Mail System (VMS) in a communication system, the method comprising:
receiving a request message for providing a voice message to a calling terminal;
determining whether the request message includes language select information indicating a language of a voice message to be provided to the calling terminal;
when the language select information is not included, detecting caller information included in the request message;
selecting a language of a voice message to be provided to the calling terminal using the detected caller information; and
transmitting a voice message corresponding to the selected language to the calling terminal.

2. The method of claim 1, wherein the caller information includes at least one of identifier information of the calling terminal, caller location information and caller country information.

3. The method of claim 1, wherein the request message includes caller information included in a call setup request message sent from the calling terminal to a called terminal.

4. The method of claim 1, wherein the voice message includes at least one of a message notifying no response to a call setup request of the calling terminal and a record information voice message for caller's message recoding.

5. The method of claim 1, further comprising:
when the language select information is included, selecting a language of a voice message to be provided to the calling terminal according to the language select information; and
transmitting a voice message corresponding to the selected language to the calling terminal.

6. The method of claim 5, wherein the voice message includes at least one of a message notifying no response to a call setup request of the calling terminal and a record information voice message for caller's message recoding.

7. The method of claim 1, further comprising:
determining whether a voice message corresponding to the selected language exists in the VMS; and
transmitting the voice message corresponding to the selected language to the calling terminal when the voice message corresponding to the selected language to the calling terminal exists.

8. The method of claim 1, further comprising:
determining whether a voice message corresponding to the selected language exists in the VMS; and
transmitting a voice message corresponding to a default language to the calling terminal when the voice message corresponding to the selected language to the calling terminal does not exist.

9. An apparatus to provide a voice message in a communication system, the apparatus comprising:
a caller information detector to, upon receiving a request message for providing a voice message to a calling terminal, determine whether the request message includes language select information indicating a language of a voice message to be provided to the calling terminal, and detect caller information included in the request message when the language select information is not included; and
a voice message reproducer to select a language of a voice message to be provided to the calling terminal using the detected caller information, and transmit a voice message corresponding to the selected language to the calling terminal.

10. The apparatus of claim 9, wherein the caller information includes at least one of identifier information of the calling terminal, caller location information and caller country information.

11. The apparatus of claim 9, wherein the request message includes caller information included in a call setup request message sent from the calling terminal to a called terminal.

12. The apparatus of claim 9, wherein the voice message includes at least one of a message notifying of no response to a call setup request of the calling terminal and a record information voice message for caller's message recoding.

13. The apparatus of claim 9, further comprising a memory for storing the voice message.

14. The apparatus of claim 9, wherein the caller information detector outputs the language select information to the voice message reproducer when the language select information is included, and further wherein the voice message reproducer selects a language of a voice message to be provided to the calling terminal according to the language select information, and transmits a voice message corresponding the selected language to the calling terminal.
